(19) United States
(12) Patent Application Publication
(10) Pub. No.: US 2001/0032822 A1
(43) Pub. Date: Oct. 25, 2001

(54) Device, method, and system for removing contaminants from a liquid

(75) Inventors: Evan E. Koslow, Weston, CT (US); Lawrence S. Walters JR., Woodbridge, CT (US); Dennis C. Bernardi, Wallingford, CT (US); Irl R. Sanders III, Milford, CT (US); Donald J. Baumgarten, Cheshire, CT (US); Stephen P. Huda, Shelton, CT (US)

Correspondence Address: Paul D. Greeley, Esq., Ohlandt, Greeley, Ruggiero & Perle, L.L.P., 10th Floor, One landmark Square, Stamford, CT, 06901-2682, US

(73) Assignee: KX Industries, L.P.

(21) Appl. No.: 09/759,593

(22) Filed: Jan. 12, 2001

Related U.S. Application Data
(60) Provisional application No. 60/177,188, filed on Jan. 15, 2000.

(51) Int. Cl. B01D 29/00

(52) U.S. Cl. 210/767; 210/464; 210/470; 210/473

(57) ABSTRACT

There is provided a beverage maker having a device that removes contaminants from a liquid, which is removably supported within a compartment for ingredients. The device is preferably a filter that is surrounded by a supporting member, which supports the device within the compartment. The supporting member around the device may have a plurality of outwardly-protruding extensions that support the device by fitting against the sidewall of the compartment. A method and a system for such a device are also provided.

This application claims priority from U.S. Provisional Patent Application Ser. No. 60/177,188, filed on Jan. 15, 2000.

### FIELD OF THE INVENTION

The present invention relates to a device capable of removing contaminants in a liquid and a method and system for such a device. More particularly, this invention relates to a device used in a brewed beverage maker for removing contaminants in a liquid and a method and system such a device.

### BACKGROUND OF THE INVENTION

Devices of various configurations for removing contaminants from liquids are employed daily in households. The term removing as used herein encompasses actions against a contaminant, such as separating, absorbing, adsorbing, capturing, binding, altering, transforming, rendering inert, and destroying.

In most households, coffee, tea, and other brewed beverages are typically made in automatic drip-type beverage makers. Such beverage makers typically have a reservoir of liquid, such as water, and heat the liquid with a thermo-siphon heater. The heated liquid is delivered to a brewing basket that contains the brewing ingredients, wherein the heated liquid steeps in the brewing ingredients. The resulting brewed beverage passes through the brewing basket into a beverage collector, or carafe, positioned below. The beverage collector is typically kept warm by a heating element.

Water and other liquids used in these drip-type beverage makers can contain contaminants. These contaminants include particulates, chemicals, and germs (i.e., viruses, bacteria, mold, pollen, oocysts, and protozoa). Common liquid-borne particulate contaminants are dirt, rust, silt, and heavy metals. Lead, a heavy metal, is particularly common because it is found in water fixtures, pipes, and pipe solder. Chemical contaminants may consist of chlorinated hydrocarbons, free chlorine, pesticides, petroleum-based chemicals, and synthetic organic chemicals. Germs that commonly contaminate water include protozoan cysts, such as Cryptosporidium Parvum and Giardia, and bacteria, such as E. coli and Cholera. Thus, not only will contaminants noticeably and adversely affect the aroma, taste, and other qualities of the brewed beverage, contaminants are also potentially dangerous to the brewed beverage drinker.

The typical brewing basket found in most beverage makers is roughly shaped as an inverted cone, conoid, or pyramid. The brewing basket supports a fluted or pleated bowl-shaped paper filter that generally conforms to the shape of the brewing basket. The principal function of the paper filter is to support the brewing ingredients and prevent them from passing into the underlying beverage collector. Thus, the paper filter that is held in the brewing basket generally does not remove liquid-borne contaminants.

A contaminant remover must be employed to remove or otherwise render inert contaminants in the liquid, ideally, before the liquid contacts the brewing ingredients. Yet, typical beverage makers cannot fit a contaminant remover between the liquid reservoir and the brewing ingredients. Reasons for this include the fact that beverage makers for home use must be compact. Also, retrofitting a contaminant remover is often not possible.

U.S. Pat. Nos. 5,318,703, 5,393,548, and 5,505,120 provide similar methods and devices for retrofitting a contaminant remover into a coffee maker. First, U.S. Pat. No. 5,318,703 provides a water filter module that includes a plurality of support feet. In operation, the water filter module is placed with its support feet on top of a mound of ground coffee. Second, U.S. Pat. No. 5,393,548 provides a method wherein a water filtration device is positioned between the hot water drip outlet and the ground coffee beans. In use, the water filtration device is inserted into the brewing basket such that the device rests on the ground coffee beans. Third, U.S. Pat. No. 5,505,120 provides an apparatus for brewing coffee having a basket for accommodating coffee grounds and a filter means located in the basket. The filter means is placed on top of the coffee grounds.

These designs suffer from several drawbacks. First, the filter device, or contaminant remover is positioned in very close proximity to the coffee grounds. Accordingly, the contaminant remover can become tainted with wet coffee grounds, thus, requiring that the contaminant remover be cleaned after each use, which is clearly inconvenient. Furthermore, the filter device is not in contact with the sidewalls of the brew basket, which results in the filter device being stabilized only by the loose brewing ingredients upon which it is placed.

The prior art illustrates that, although many different devices presently exist that remove contaminants in liquid used to brew beverages, there is still a need for a device that can be used in existing beverage makers to remove liquid-borne contaminants, is convenient to use, clean, and replace, and has a low resistance to flow. Ideally, such a contaminant remover will not come in contact with the brewing ingredients.

### SUMMARY OF THE INVENTION

There is provided a beverage maker having a device that removes contaminants from a liquid, which is removably supported within a compartment for ingredients. The device is preferably a filter that is surrounded by a supporting member, which supports the device within the compartment. The supporting member around the device may have a plurality of outwardly-protruding extensions that support the device by fitting against the sidewall of the compartment. A method and a system for such a device are also provided.

### BRIEF DESCRIPTION OF THE DRAWINGS

FIG. 1 is a perspective view of a device according to the present invention;

FIG. 2 a top view of the device of FIG. 1;

FIG. 3 is a cross-sectional view of the device of FIG. 1 along line a-a;

FIG. 4 is a cross-sectional view of a brewing basket having the filter of FIG. 1 positioned therein;

FIG. 5 is a cross-sectional view of a preferred embodiment of the filter media for the filter of FIG. 1; and

FIG. 6 is a cross-sectional view of an alternate preferred embodiment of the filter media for the filter of FIG. 1.

FIGS. 7 through 11 is a device according to the present invention having filter medium supports adapted for use as an integrated handle.

### DETAILED DESCRIPTION OF THE INVENTION

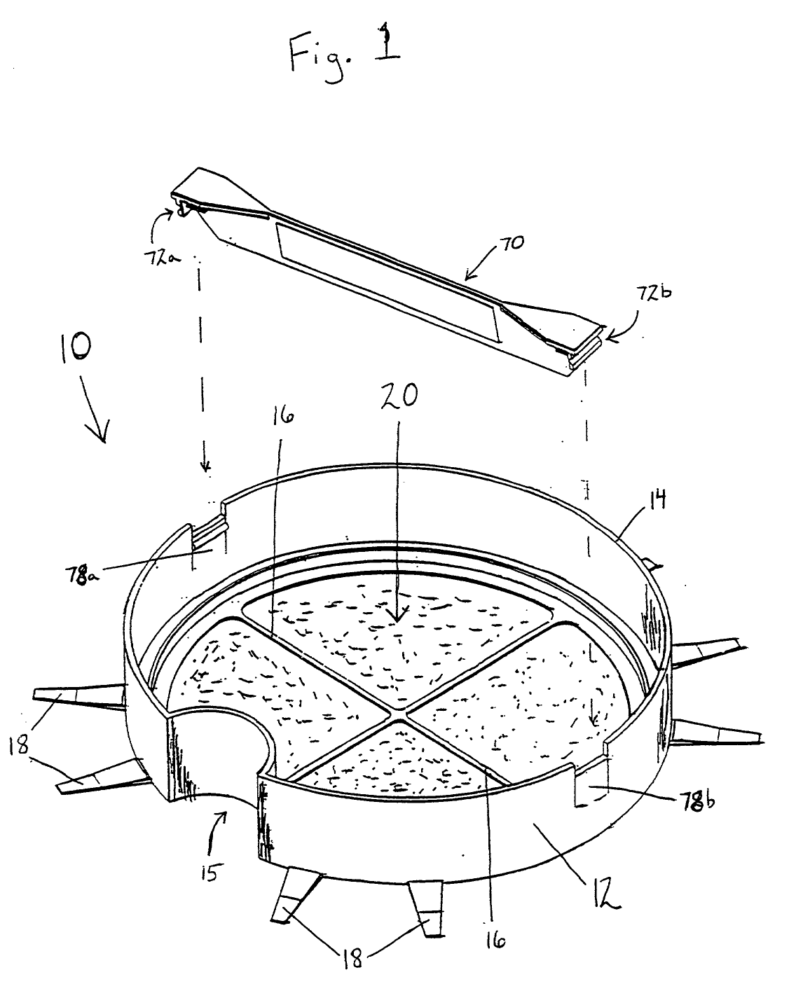

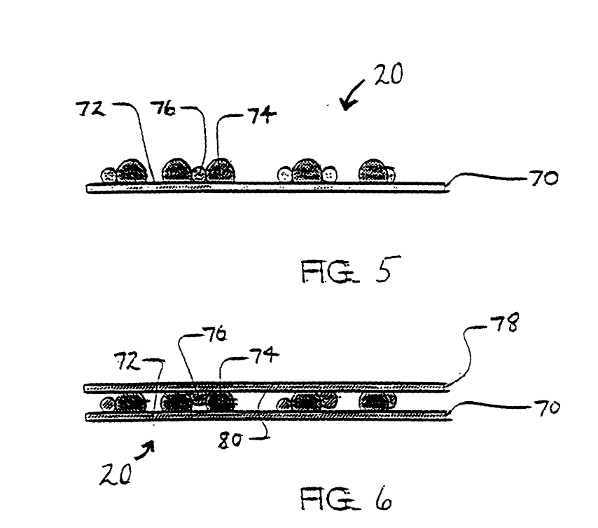

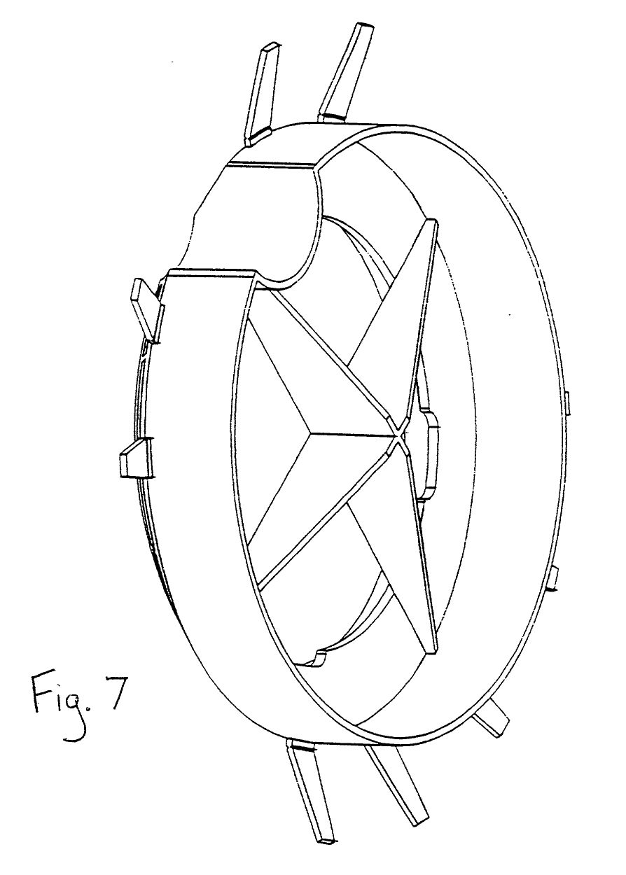

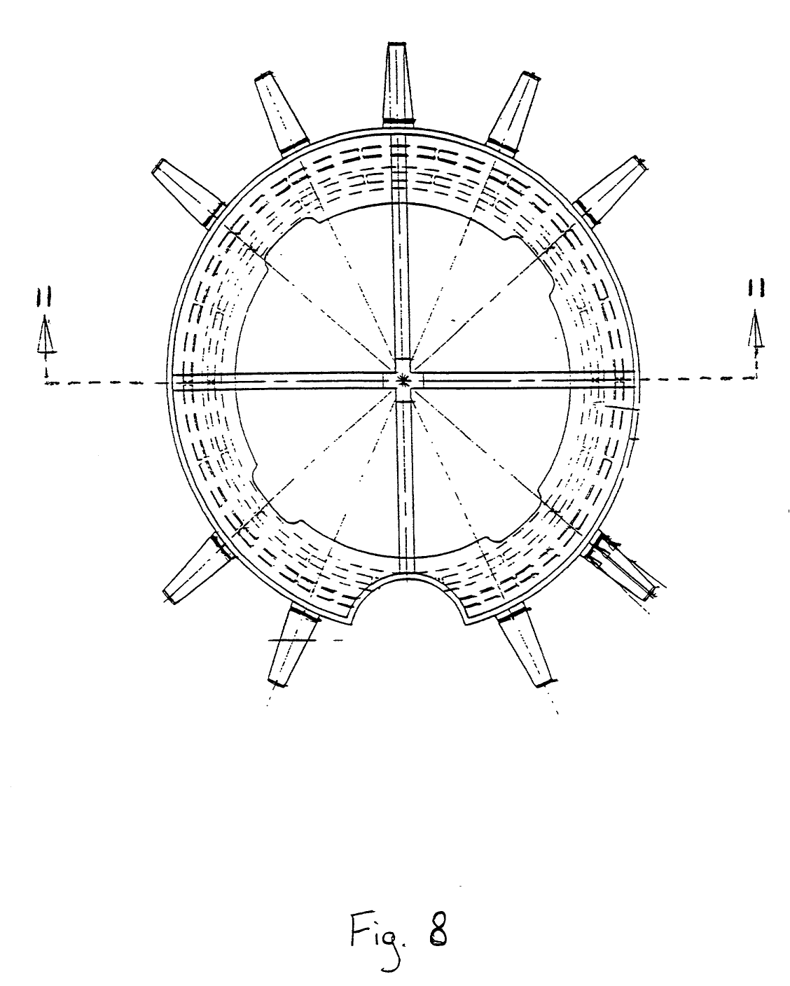

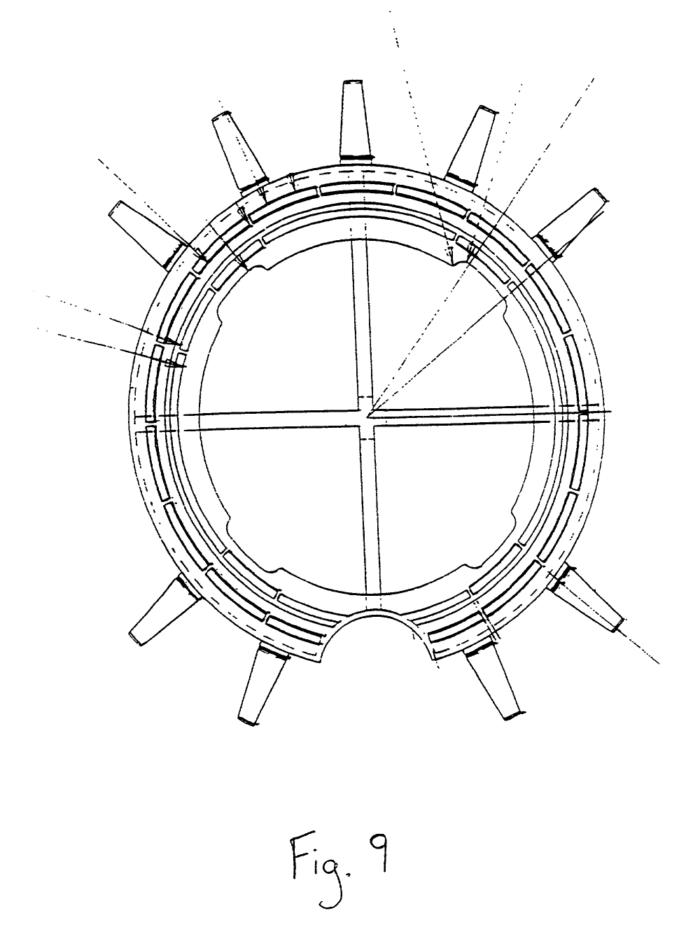

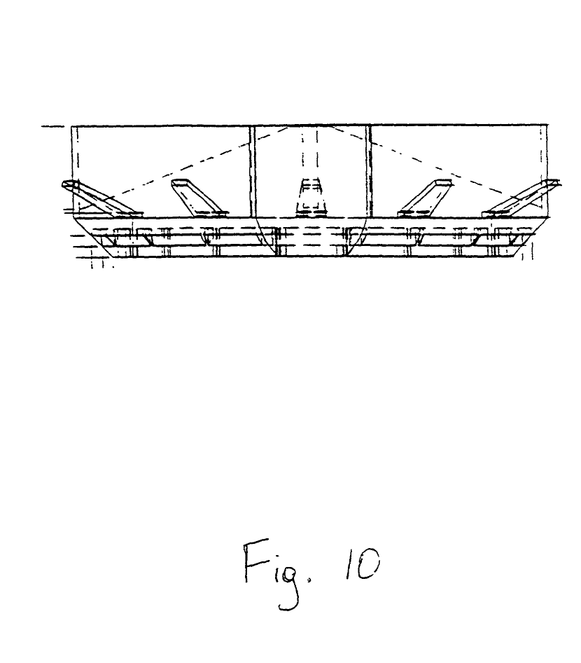

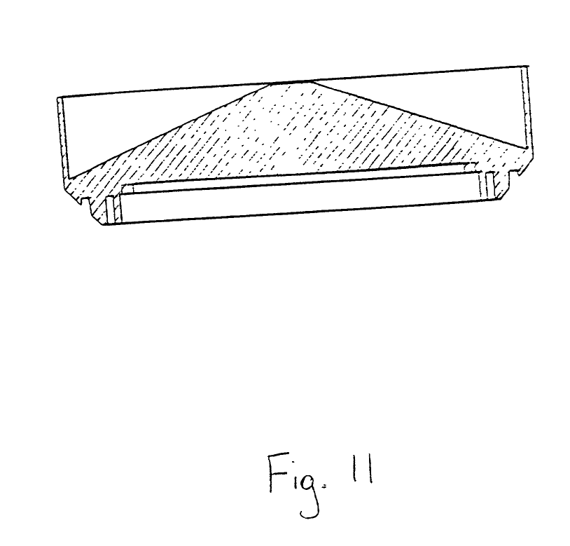

FIG. 1 illustrates a contaminant removing device embodying the present invention, referred to generally as 10, which is adapted to remove contaminants from a liquid used to brew beverages. Device 10 preferably has a filter medium 20 and a surrounding wall or frame 12. Device 10 is ideally intended for use in brew basket 50 (see FIG. 4) of a typical brewed beverage maker and the area and height of device 10 are preferably dimensioned so that device 10 will fit completely therein, yet remain separated from any brewing ingredients 55 contained in brew basket 50.

Wall or frame 12 surrounds filter medium 20 and is adapted to support filter medium 20 during the use of device 10. Wall 12 may be formed of any suitable material and, preferably, is formed of a thermoplastic material, such as polyethylene.

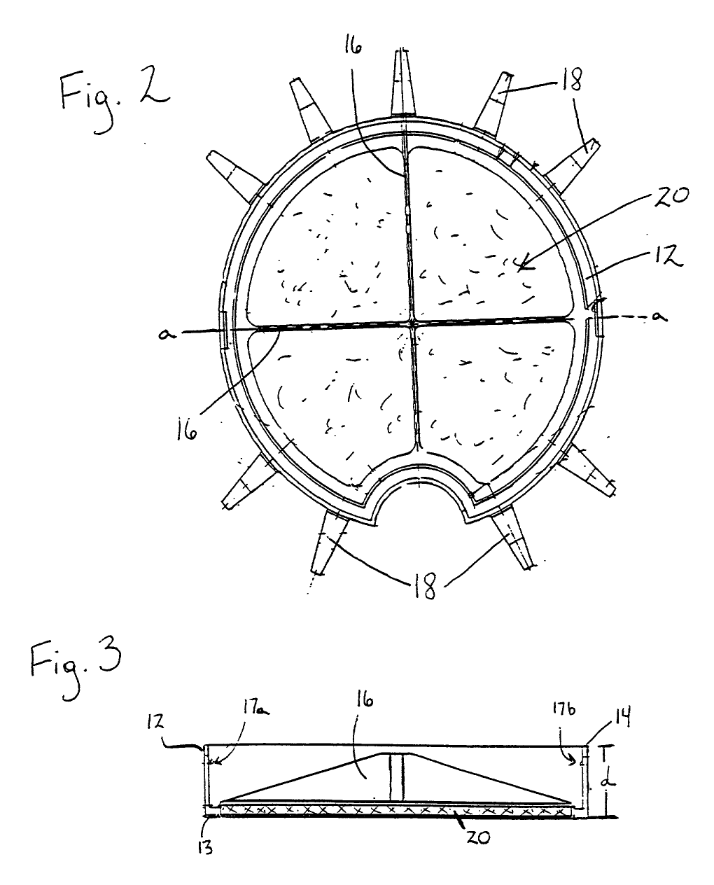

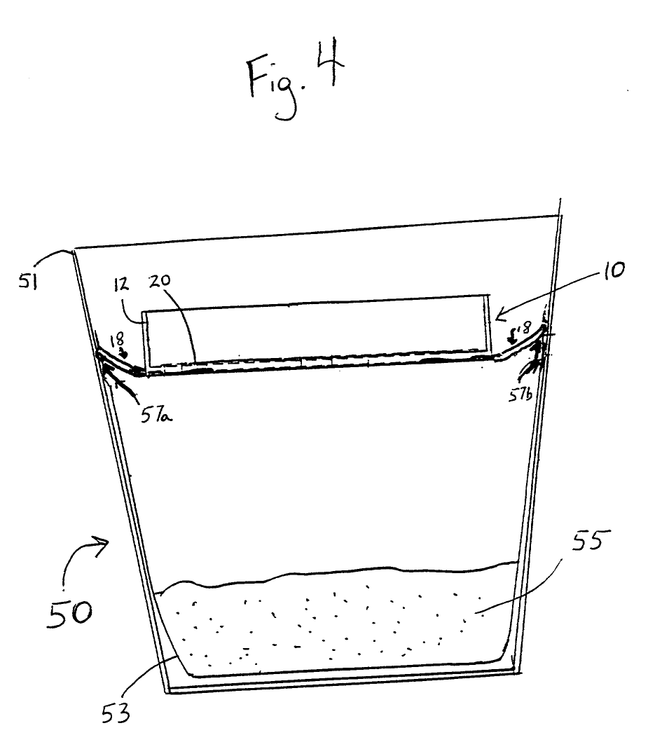

A reserve capacity is preferably created by extending wall 12 above filter medium 20 since liquid may enter device 10 more quickly than it can pass therethrough. The reserve capacity is defined by a distance d (see FIG. 3), which is between a top rim 14 of wall 12 and filter medium 20, multiplied by the area of filter medium 20. The area of filter medium 20 should be made as large as reasonably possible, while distance d should be configured to provide enough reserve capacity to prevent the overflow of liquid. The preferred distance d will depend on the flow rate of liquid through filter medium 20 and the size of brew basket 50.

Although wall 12 is preferably an annular sidewall surrounding a circular-shaped filter medium 20, wall 12 may take any form dictated by the application environment. A circular shape is useful for a brew basket that is generally shaped as an inverted cone or conoid. Also, wall 12 may be provided with features that are appropriate for the application environment, such as an inwardly projecting semicircular indentation 15 or a tapered bottom rim 13 (not shown).

Wall 12 may be releasably or permanently attached to filter medium 20 using any technique know to the art. For example, in a preferred embodiment of device 10, filter medium 20 is heat sealed to wall 12. Wall 12 may alternatively be insert molded around filter medium 20. A further alternative would be adapting wall 12 to releasably receive filter medium 20 so that filter medium 20 could be replaced when necessary. If filter medium 20 was releasably attached to wall 12, it would be preferable that filter medium 20 have a rigid or semi-rigid rim disposed thereabout, which is adapted to be snap-fit onto wall 12.

Wall 12 is preferably provided with a plurality of outwardly protruding extensions 18. Although, extensions 18 may extend from top rim 14 of wall 12 or at substantially any position between top rim 14 and a bottom rim 13, extensions 18 are preferably disposed in close proximity to bottom rim 13. Extensions 18 protrude outwardly a sufficient length to enable contact with brew basket 50 (see FIG. 4). It is preferable that extensions 18 are flexibly attached to wall 12 so that extensions 18 may move relative to wall 12. By flexibly connecting extensions 18 to wall 12, exentions 18 may pivot relative to wall 12 until to top of device 10 sits below the top rim 61 of beverage brewing basket 50, while remaining above the brewing ingredients. The flexing area of extensions 18 are preferably designed to allow for maximum flexing with minimum force, without fracturing. Extensions 18 may be initially set perpendicular or at an angle relative to wall 12. Extensions 18 are preferably formed of the same or similar material as wall 12. Furthermore, extensions 18 are preferably integrally formed with wall 12.

Supports 16 may be attached to wall 12 and project inwardly so as to reinforce filter medium 20. A set of supports 16 may be positioned both on top and below filter medium 20. Supports 16 may also be configured as inwardly projecting fins (see FIG. 3), which extend in parallel with wall 12, as well as project inwardly therefrom. If supports 16 are configured as fins, supports 16 may be adapted for a user to grip device 10 therewith. Like extensions 18, it is preferable that supports 16 be formed of the same or similar material as wall 12. It is also preferable that supports 16 are integrally formed with wall 12.

Device 10 may include a pair of opposing inwardly projecting ridges 17a and 17b (see FIG. 3) disposed in close proximity to the top rim 14. Ridges 17a, 17b are intended to releasably engage a pair of grooves 72a, 72b located at flared opposite ends of an elongated handle 70. To facilitate the attachment of handle 70 to wall 12, the opposing inwardly projecting ridges 17a, 17b may be positioned at a remote end of a pair of opposing resilient cantilevered latching members 78a, 78b. Cantilevered latching members 78a, 78b may be made slightly shorter than top rim 14 so as to provide notched regions for receiving flared handle ends 74a, 74b and for permitting handle 70 to sit substantially flush with top rim 14, thusly providing a compact assembly. Alternatively, handle 70 may be integrally attached to wall 12.

Filter medium 20 may be of any type including separating mediums and adsorbing mediums. For example, metallic mesh screens, spun-bonded or melt-blown polymeric non-woven materials, glass fibers, porous membranes, and paper may be used as separating mediums. Adsorbing mediums include iodinated resin, activated carbon, activated alumina, alumina-silicates, ion-exchange resins, manganese or iron oxides, and other materials having well-defined pore structures due to a high degree of crystallinity, such as zeolites. Filter medium 20 should provide suitably high flow and minimal pressure drop because the reserve capacity may be limited due to practical height constraints placed on the brewed beverage maker, particularly if designed for domestic use.

As shown is FIG. 5, filter medium 20 is most preferably a composite structure formed by an adsorbent supporting web substrate 70 having a surface 72 fused to a mixture of adsorbent particles 74 and binder particles 76. Adsorbent particles 74 are coalesced or fused together by binder particles 76, which are interposed therebetween. Also, some of the binder particles are fused to surface 72. The composite structure is preferably obtained according to the method described in U.S. Pat. No. 5,792,513, issued on Aug. 11, 1998, which is incorporated in its entirety herein by reference. As described therein, a mixture of adsorbent particles 74 and binder particles 76 is applied to part or all of surface 72, thereby producing a loose powder coating on surface 72. The loose powder coating is heated to at least the Vicat softening temperature of binder particles 76, but below the melting temperature of adsorbent supporting substrate 70 and adsorbent particles 74. Pressure is applied to web substrate 70 to cause the softened binder particles to coalesce, or fuse together, adsorbent particles 74, as well as adhere adsorbent particles 74 to adsorbent supporting web substrate 70.

Filtration medium 20 comprises an adsorbent supporting web substrate 70 that may be formed preferably using non-woven fibrous materials, such as the spun-bonded polyesters and polyolefins. Woven substrates may also be used. Furthermore, adsorbent supporting web substrate 70 may optionally be formed using cellulosic materials, such as paper, or a combination of cellulosic and thermoplastic fibers.

Materials forming binder particles 76 typically include thermoplastics such polypropylene, linear low-density polyethylene, low density polyethylene and ethylene-vinyl acetate copolymer.

Referring to FIG. 6, filter medium 20 can be modified to include an overlying web substrate 78, which could be formed of materials similar to supporting web substrate 70. Overlying web substrate 78 has a surface 80 facing coated surface 72 of adsorbent supporting web substrate 70. Adsorbent particles 74 may also be adhered to surface 80 of overlying web substrate 78 by binder particles 76. The fusing of adsorbent particles 74, supporting substrate 70, and overlying web substrate 78 can be accomplished according to the disclosure in U.S. Pat. No. 5,792,513. Essentially, after applying the mixture of adsorbent and binder particles to the surface of adsorbent supporting web substrate 70 to produce a powder coating covering at least a portion thereof, as described above, overlying web substrate 78 is applied over both adsorbent supporting web substrate 70 and the powder coating thereon. Heat and pressure is applied to adsorbent supporting web substrate 70 and overlying web substrate 78 to soften binder particles 76. The softened binder particles coalesce, or fuse together, adsorbent particles 74, as well as adhere adsorbent particles 74 to web substrates 70, 78.

Both the adsorbent supporting web substrate 70 and the overlying web substrate 78 may provide supplemental particulate filtration. For example, filter medium 52 can reduce certain waterborne oocysts when web substrate 70 and overlying web substrate 78 are composed of a fine hydrophilic particulate filter medium, potentially combined with adsorbents such as activated carbon and heavy metal adsorbing zeolites. Co-pending U.S. patent application Ser. No. 09/140,924, filed Aug. 27, 1998, and assigned to the assignee hereof describes a low flow resistance composite filter medium for capturing at least 99.95 percent of particulates of a size in the 3 to 4 micron range, such as oocysts, and dissolved chemical contaminants from a fluid that can be used as a high flow rate filter medium in the present invention. The subject matter of that application is incorporated herein by reference in its entirety.

In use, as illustrated in FIG. 4, a liquid permeable holder for brewing ingredients, such as paper coffee grounds filter 53, is placed within brew basket 50 and brewing ingredients are placed thereupon. Optionally, brewing ingredients can simply be placed within brew basket 50. Device 10 is then fitted within brew basket 50. Extensions 18 engage brew basket 50. Thereby, brew basket 50 supports device 10 between top rim 51 and brewing ingredients 55. In addition, brew basket 50 may be provided with indentations 57a, 57b to better facilitate the fitting of device 10. Liquid is then passed through device 10. Contaminants in the liquid are removed, killed, or rendered inert by device 10 before the liquid mixes with brewing ingredients 55.

During use, device 10 is in direct contact with the liquid being passed therethrough. When hot liquid (about 185° F.) is used, the material forming device 10 is heated, which reduces the stresses incurred at the hinge areas of extensions 18. Reducing the stress at the hinge areas results in extensions 18 taking on a permanent set for future use.

There are two primary benefits of fitting device 10 distal to top rim 51 and separated from brewing ingredients 55. First, device 10 may be retrofitted into virtually any beverage brewer. Second, device 10 will not become contaminated with wet brewing ingredients.

The present invention having been thus described with particular reference to the preferred form thereof, it will be obvious that various changes and modifications may be made therein without departing from the spirit and scope of the invention as defined in the appended claims.

Wherefore we claim:

1. A device comprising:
means for removing contaminants from a liquid, said means for removing adapted to be releasably supported upon a wall member of a compartment having beverage ingredients, wherein said removing means is separated from said ingredients.

2. The device of claim 1, wherein said means for removing comprises a wall defining a periphery of said means for removing.

3. The device of claim 2, wherein said wall is adapted to hold said liquid within said means for removing.

4. The device of claim 1, wherein said means for removing comprises a plurality of outwardly extending protrusions adapted to be releasably supported upon said wall member.

5. The device of claim 4, wherein said protrusions are flexibly connected to said means for removing.

6. The device of claim 1, wherein said means for removing comprises a handle.

7. The device of claim 6, wherein said handle is releasably attached to said means for removing.

8. The device of claim 1, wherein said means for removing comprises a filtration medium.

9. The device of claim 8, wherein said filtration medium is at least one material selected from the group consisting of: metallic mesh screen, polymeric non-woven material, glass fiber, microporous membrane, paper, iodinated resin, activated carbon, activated alumina, alumina-silicates, ion-exchange resins, manganese oxides, iron oxides, zeolite, and combinations thereof.

10. The device of claim 8, wherein said means for removing further comprises a supporting arm adapted to support said filtration medium.

11. The device of claim 10, wherein said supporting arm is further adapted to be used as a handle for said means for removing.

12. The device of claim 1, wherein said means for removing comprises a filtration medium and a supporting structure.

13. The device of claim 12, wherein said filtration medium is heat sealed to said supporting structure.

14. The device of claim 12, wherein said supporting structure is insert molded around said filtration medium.

15. A method comprising:
supporting a means for removing contaminants from a liquid in contact with a wall member of a compartment having beverage ingredients, wherein said means for removing is separated from said ingredients; and
passing said liquid through said removing means before said liquid contacts said ingredients.

16. A system comprising:
means for removing contaminants from a liquid; and
a compartment having beverage ingredients,
wherein said means for removing is adapted to be releasably supported about the interior of said compartment, and wherein said removing means is separated from said ingredients.
